(19) United States
(12) Patent Application Publication
(10) Pub. No.: US 2011/0164066 A1
(43) Pub. Date: Jul. 7, 2011

(54) ELECTRONIC READING DEVICE

(76) Inventors: TODD BEALS, WESTFIELD, IN (US); NEWTON GUILLEN, CARMEL, IN (US); STUART OUGH, INDIANAPOLIS, IN (US)

(21) Appl. No.: 12/651,830

(22) Filed: Jan. 4, 2010

(51) Int. Cl. G06F 3/02; G09G 5/00

(52) U.S. Cl. 345/685; 345/169

(57) ABSTRACT

An electronic reading device provides automatic adjustment of image display and key functionality. An actuator and a plurality of keys symmetrically control the electronic reading device. A built-in motion detection mechanism detects changes in the orientation of the electronic reading device. The content of the display and the functionality of the actuator and plurality of keys is automatically adjusted based on the orientation of the device such that the actuator and the plurality of keys perform identical functions in a current orientation as were performed in a previous orientation.

### BACKGROUND

1. Technical Field

The present disclosure relates to an electronic reading device, and more specifically, to an electronic reading device providing the same user experience and identical functionality to both left-handed and right-handed users by utilizing an actuator and a plurality of keys to symmetrically control the electronic reading device.

2. Discussion of Related Art

Electronic reading devices present an electronic version of a book—otherwise known as an e-book, electronic book or digital book—to a user. Electronic reading devices are sometimes referred to as e-readers or e-book readers. Electronic reading devices are commonly designed for two-handed use. For example, one hand is regularly used to hold the device while the other hand is used to turn the page of the e-book or control other functions of the device. Electronic reading devices that are designed for one-handed use are often designed to be operated by a primary hand. Thus, users who want to use the device with the non-primary hand according to the device's design will not have access to all of the functions of the device that would be available if the device was being used with the primary hand. Electronic reading devices may also be designed with only one vertical orientation and/or one horizontal orientation being supported, further limiting the function of the device for a user who wants to use the device with the non-primary hand according to the device's design.

Therefore, a need exists for an electronic reading device that allows comfortable, one-handed use and provides identical functionality regardless of whether the device is being held and operated with a user's right hand or left hand.

### BRIEF SUMMARY

According to an embodiment of the present disclosure, an electronic reading device comprises a display, an actuator adjacent to a first side of the display, a plurality of keys adjacent to a second side of the display, opposite the first side of the display, and an orientation detection mechanism. The actuator and the plurality of keys symmetrically control the electronic reading device. The orientation detection mechanism detects an orientation change of the electronic reading device. Upon detecting an orientation change of approximately 180 degrees, the actuator and the plurality of keys are redefined to perform identical functions in a current orientation as were performed in a previous orientation.

The actuator and the plurality of keys may be configured for right-handed use in the previous orientation and reconfigured for left-handed use in the current orientation.

The actuator may comprise a rocker bar. Pushing the rocker bar in a first direction performs a first function and pushing the rocker bar in a second direction, opposite the first direction, performs a second function. The first function may comprise displaying a subsequent page of an e-book and the second function may comprise displaying a previous page of the e-book.

According to an embodiment of the present disclosure, a method for operating an electronic reading device comprises performing a first function in response to a switch being pushed in a first direction and performing a second function in response to the switch being pushed in a second direction, and redefining the switch such that pushing the switch in the first direction performs the second function and pushing the switch in the second direction performs the first function, upon detecting an orientation change of the electronic reading device of approximately 180 degrees.

According to an embodiment of the present disclosure, a method for operating an electronic reading device comprises displaying a subsequent page of an e-book in response to a rocker bar being pushed in a first direction, displaying a previous page of the e-book in response to the rocker bar being pushed in a second direction, opposite the first direction, scrolling text on a display down in response to pushing a first key, scrolling text on the display up in response to pushing a second key, and, upon detecting an orientation change of the electronic reading device of approximately 180 degrees, inverting content on the display, displaying a subsequent page of the e-book in response to the rocker bar being pushed in the second direction, displaying a previous page of the e-book in response to the rocker bar being pushed in the first direction, scrolling text on the display down in response to pushing the second key and scrolling text on the display up in response to pushing the first key.

### BRIEF DESCRIPTION OF THE SEVERAL VIEWS OF THE DRAWINGS

Preferred embodiments of the present disclosure will be described below in more detail, with reference to the accompanying drawings:

FIG. 1A illustrates a front view of the electronic reading device comprising a rocker bar as an actuator, according to an embodiment of the present disclosure.

FIG. 1B illustrates a front view of the electronic reading device comprising a switch as an actuator, according to an embodiment of the present disclosure.

FIG. 1C illustrates a front view of the electronic reading device comprising two buttons in place of an actuator, according to an embodiment of the present disclosure.

FIG. 2 illustrates the bi-directional rocker bar of the electronic reading device, according to an embodiment of the present disclosure.

FIGS. 3A-3D illustrate the electronic reading device configured for use in different horizontal and vertical positions, according to an embodiment of the present disclosure.

FIG. 4 is a flowchart illustrating the process of adjusting the content on the display and redefining the functions of the rocker bar and the plurality of keys upon detecting a change in orientation of the electronic reading device, according to an embodiment of the present disclosure.

FIG. 5 illustrates components of the electronic reading device, according to an embodiment of the present disclosure.

FIG. 6 illustrates a side view of the electronic reading device, including a microphone input, an SD card slot and a power/lock switch, according to an embodiment of the present disclosure.

FIG. 7 illustrates a side view of the electronic reading device, including a headphone jack and a connection port (e.g., mini-USB port, micro-USB port, etc.), according to an embodiment of the present disclosure.

### DETAILED DESCRIPTION

Exemplary embodiments of the present invention now will be described more fully hereinafter with reference to the accompanying drawings. This invention, may however, be embodied in many different forms and should not be construed as limited to the embodiments set forth herein.

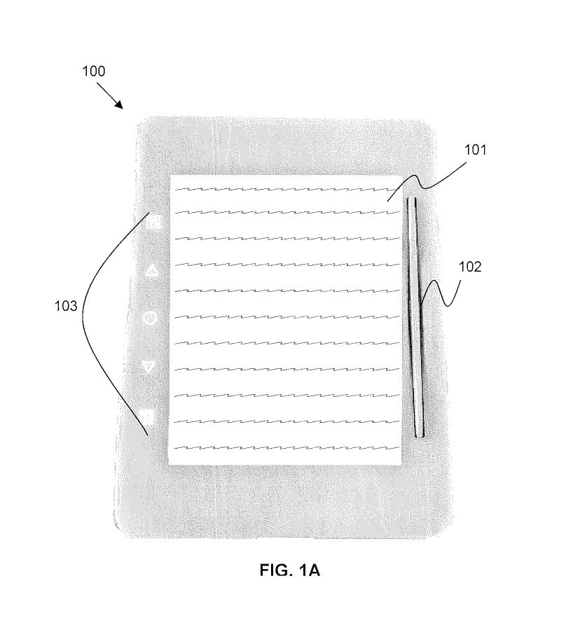

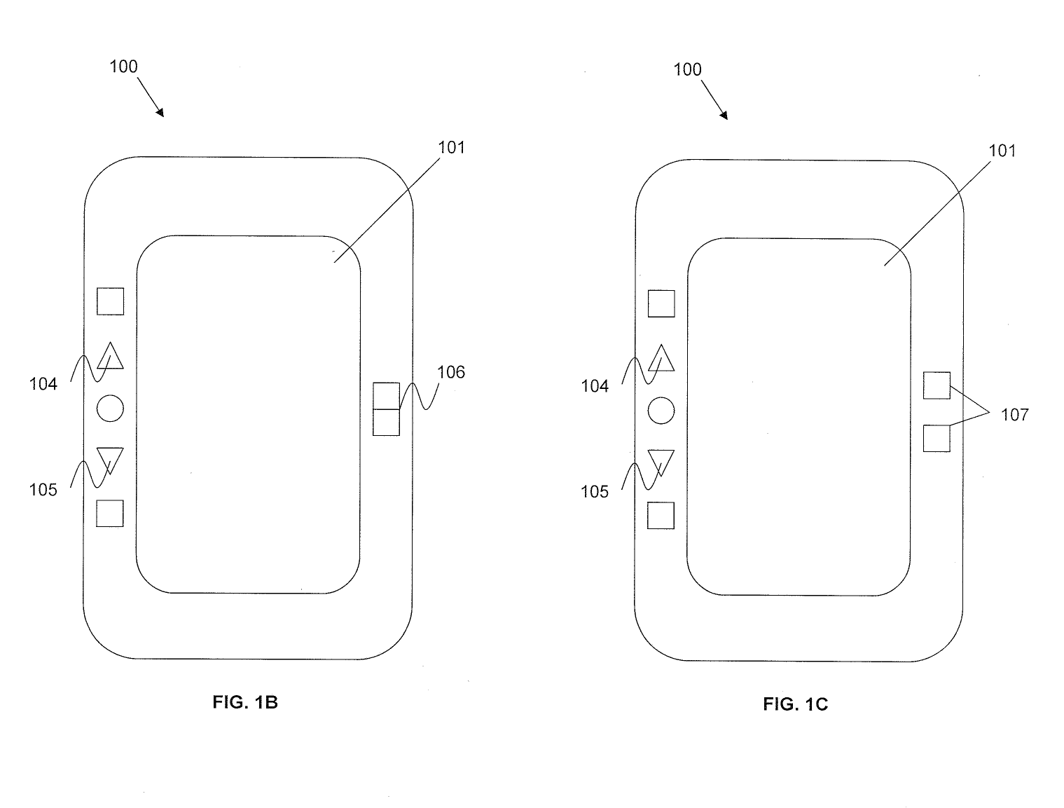

According to an embodiment of the present disclosure, the electronic reading device comprises a display, an actuator, a plurality of keys and an orientation detection mechanism. The actuator is utilized to flip back and forth between pages of an e-book, and may comprise any input device capable of performing two functions, such as, for example, a bi-directional rocker bar 102, as illustrated in FIG. 1A, or a switch 106, as illustrated in FIG. 1B. In another embodiment of the present disclosure, the actuator may be replaced with two buttons 107, as illustrated in FIG. 10. For exemplary purposes, a rocker bar 102 is utilized in the embodiments described throughout the description, however, the rocker bar 102 may be replaced with a switch 106 as shown in FIG. 1B, or two buttons 107 as shown in FIG. 10, in any of the embodiments.

FIG. 1A illustrates an electronic reading device 100 according to an embodiment of the present disclosure. In this embodiment, the electronic reading device 100 includes a display 101, a bi-directional rocker bar 102 and a plurality of keys 103, all positioned on a surface of the main body of the device. The bi-directional rocker bar 102 is located adjacent to a first side of the display 101 and the plurality of keys is located adjacent to a second side of the display 101. This configuration provides symmetrical control of the electronic reading device 100 by allowing a user to rotate the device 100 180 degrees without a change in functionality of the rocker bar 102 or the plurality of keys 103. The plurality of keys 103 may be physical keys located on the main body of the electronic reading device 100 or onscreen keys located on the device's display 101. The device 100 further includes a built-in motion detection mechanism.

The display 101 may comprise, but is not limited to, an electronic ink (e-Ink) display, a liquid crystal display (LCD) or an organic light emitting diode (OLED) display. The display 101 may further comprise a touch-screen interface which can be used for user input. For example, a user may use a touch-screen interface to enter input via onscreen keys, a virtual keyboard or user gestures. The user can also utilize the touch-screen interface to make annotations in e-books (e.g., highlighting text, writing notes, etc.). In an embodiment of the present disclosure, a light source may be utilized to illuminate the display 101, which allows for reading of the device 100 in dark environments. For example, a backlight may be located beneath the display 101 or LED lights may be placed around the perimeter of the display 101.

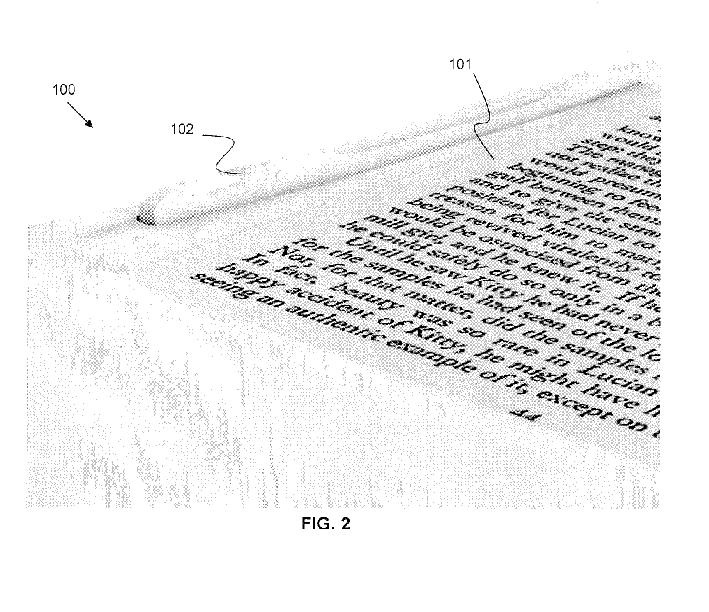

As shown in FIG. 1A, the rocker bar 102 may be positioned parallel and adjacent to one of the longer sides of the display 101, and the length of the rocker bar 102 may be approximately the same as the length of the longer sides of the display 101. The rocker bar 102 defaults to a center position and pivots about a fixed axis, functioning as a two-way switch. This allows the user to push the rocker bar 102 in opposite directions to achieve different functions, for example, to advance to the next page of an e-book or to go back to the previous page of an e-book. This configuration results in the ability to comfortably hold the device 100 and turn the pages of an e-book with one hand, using a thumb. The rocker bar 102 is further illustrated in FIG. 2. In other embodiments, the rocker bar 102 may be replaced with a switch 106 or two buttons 107, as illustrated in FIGS. 1B and 1C.

The built-in motion detection mechanism is utilized to automatically adjust the orientation of content on the display 101 and to redefine the functionality of the rocker bar 102 and the plurality of keys 103, according to the current orientation of the electronic reading device 100. The motion detection mechanism uses the principle of conservation of angular momentum to measure, determine and maintain the orientation of the electronic reading device 100 relative to an upward direction. The mechanism may be an accelerometer, a gyroscope, a tilt switch array, or any other electronic circuitry capable of detecting a change in orientation of the electronic reading device 100. In an embodiment of the present disclosure, the user may enable/disable the automatic re-orientation feature of the device 100, manually set the orientation of the device 100 or lock the device 100 to a particular orientation.

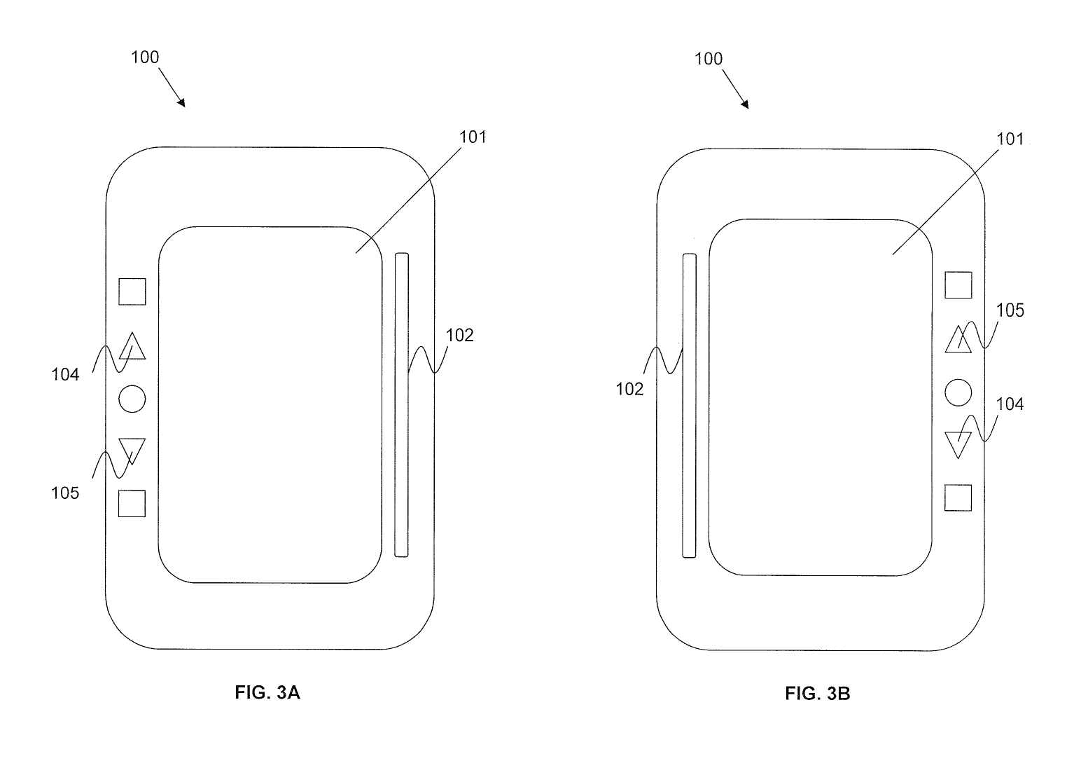

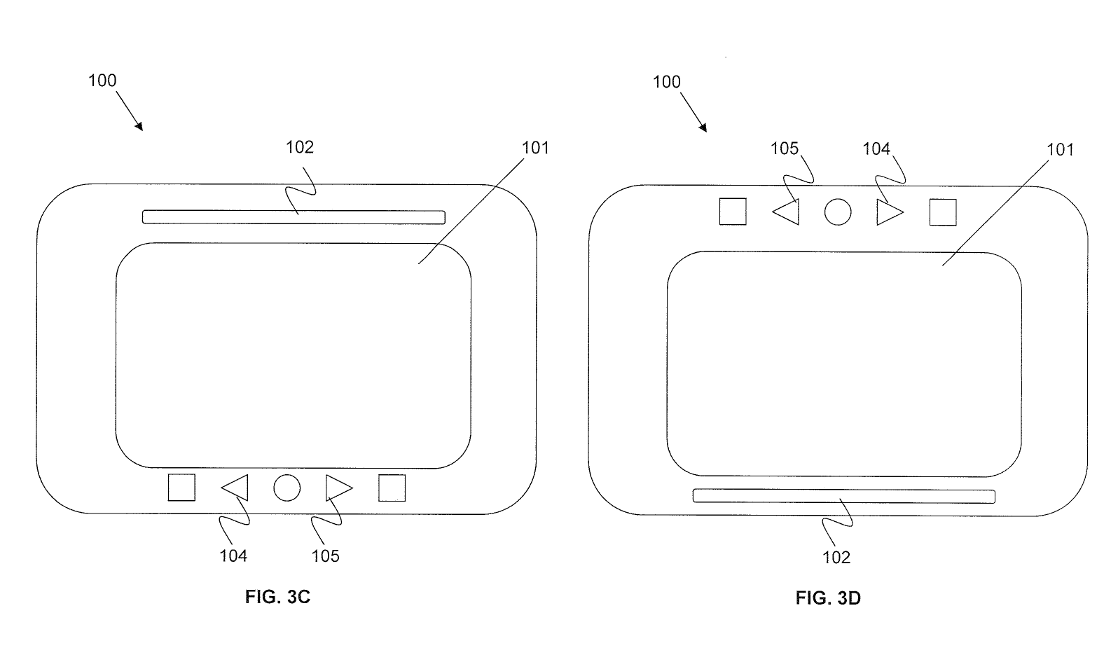

The combination of the rocker bar 102, the plurality of keys 103 and the motion detection mechanism provides the user with a seamless transition when changing the orientation of the electronic reading device 100. This allows the user to quickly and easily switch hands while holding and operating the device 100 without experiencing a loss or change in functionality. For example, consider the embodiment illustrated in FIG. 3A, which shows the electronic reading device 100 positioned for right-handed use. When held in this position, pushing the rocker bar 102 to the user's right will advance the e-book to the next page and pushing the rocker bar 102 to the user's left will go back to the previous page of the e-book. Pushing key 104 will scroll up on the display 101 and pushing key 105 will scroll down on the display 101. A user may decide to hold and operate the device 100 with his/her left hand rather than his/her right hand. In this case, the device 100 is rotated 180 degrees by the user so that the rocker bar 102 is accessible with the user's left hand, as illustrated in FIG. 3B. Similarly, the user may rotate the device 100 90 degrees so that the device 100 can be used in landscape mode rather than portrait mode, as illustrated in FIGS. 3C and 3D.

When the electronic reading device 100 is rotated, the motion detection mechanism detects this change and automatically adjusts the content on the display 101 and redefines the functionality of the rocker bar 102 and the plurality of keys 103 based on the current orientation of the device 100. For example, when the device 100 is rotated from the position shown in FIG. 3A to the position shown in FIG. 3B, the functions of the rocker bar 102 are redefined so that pushing the rocker bar 102 to the user's right will still advance the e-book to the next page and pushing the rocker bar 102 to the user's left will still go back to the previous page of the e-book, even though the rocker bar 102 is actually being pushed in opposite directions in FIG. 3B compared to FIG. 3A. The functionality of the plurality of keys 103 is also automatically adjusted based on the current orientation so that, for example, pushing key 104 will now scroll down on the display 101 and pushing key 105 will now scroll up on the display 101. As a result, the functionality of the rocker bar 102 and the plurality of keys 103 is unchanged when rotating the device 100. Similarly, when the device 100 is held horizontally, as illustrated in FIGS. 3C and 3D, pushing the rocker bar 102 up will advance the e-book to the next page and pushing the rocker bar 102 down will go back to the previous page of the e-book, even though the rocker bar 102 is actually being pushed in opposite directions in FIGS. 3C and 3D. The functionality of the plurality of keys 103 is also adjusted so that, for example, pushing key 104 will scroll down on the display 101 in FIG. 3C and up on the display 101 in FIG. 3D, and key 105 will scroll up on the display 101 in FIG. 3C and down on the display 101 in FIG. 3D. In an embodiment of the present disclosure, the electronic reading device may support four distinct configurations corresponding to four distinct orientations (e.g., the orientations depicted in FIGS. 3A-3D). Further, the motion detection mechanism may be utilized to turn off the display 101 of the device 100 or to put the device 100 into a low power mode (e.g., sleep mode, standby mode) when the device 100 is turned upside down.

It is to be understood that the functions of the rocker bar 102 and the plurality of keys 103, including keys 104 and 105, as described above are for exemplary purposes, and the invention is not limited to a device 100 having these particular function/key mappings. For example, referring to FIGS. 3C and 3D, the electronic reading device may be configured such that pushing the rocker bar 102 down advances an e-book to the next page and pushing the rocker bar 102 up goes back to the previous page of the e-book. The functionality of keys 104 and 105 may be similarly switched.

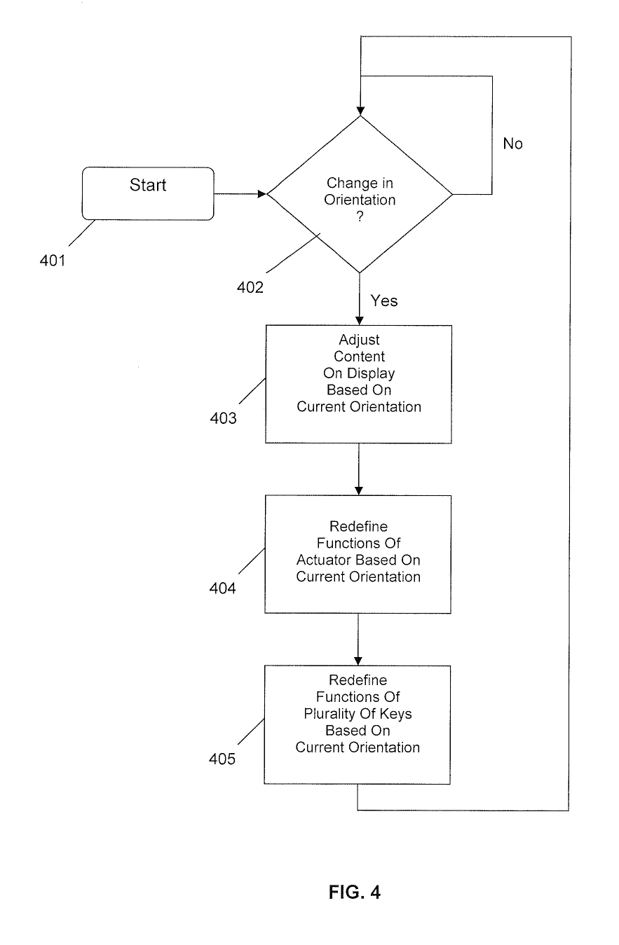

FIG. 4 illustrates the process of adjusting the content on the display 101 and redefining the functions of the actuator and the plurality of keys 103 upon detecting a change in orientation of the electronic reading device 100. The process begins at a step 401. At a step 402, the orientation of the electronic reading device 100 is continuously checked. Once a change in orientation is detected, the process proceeds to a step 403, where content on the display 101 of the electronic reading device 100 is adjusted based on the current orientation. At a step 404, the functions of the actuator are redefined based on the current orientation. At a step 405, the functions of the plurality of keys 103 are redefined based on the current orientation. The process then returns to step 402 to continue monitoring the electronic reading device 100 for any further changes in orientation.

In an embodiment of the present disclosure, the electronic reading device 100 allows text of an e-book to be searched and allows the font type/size to be changed. The device 100 may also allow a user to bookmark pages in an e-book.

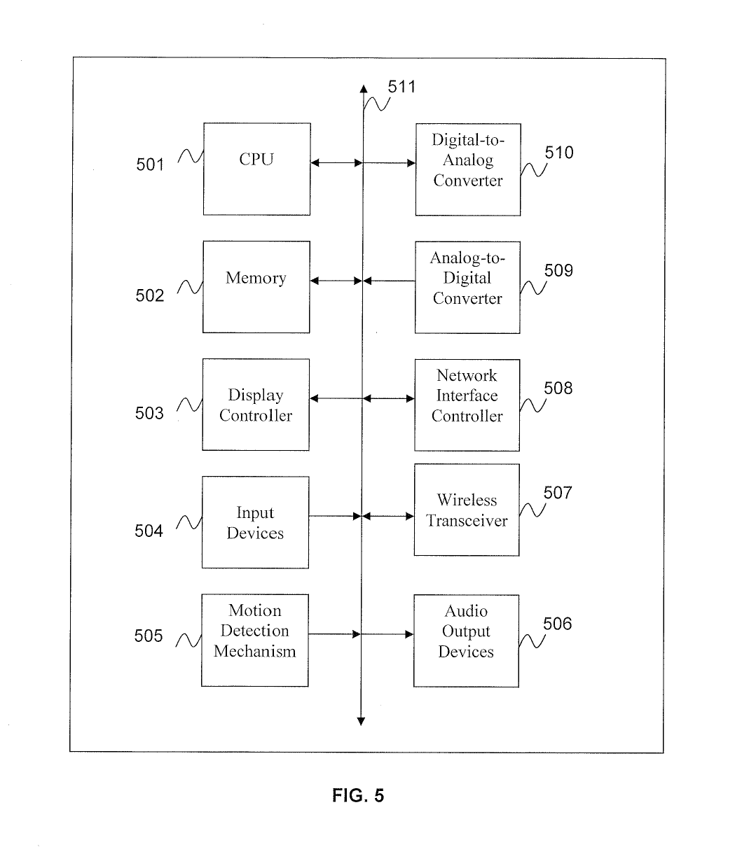

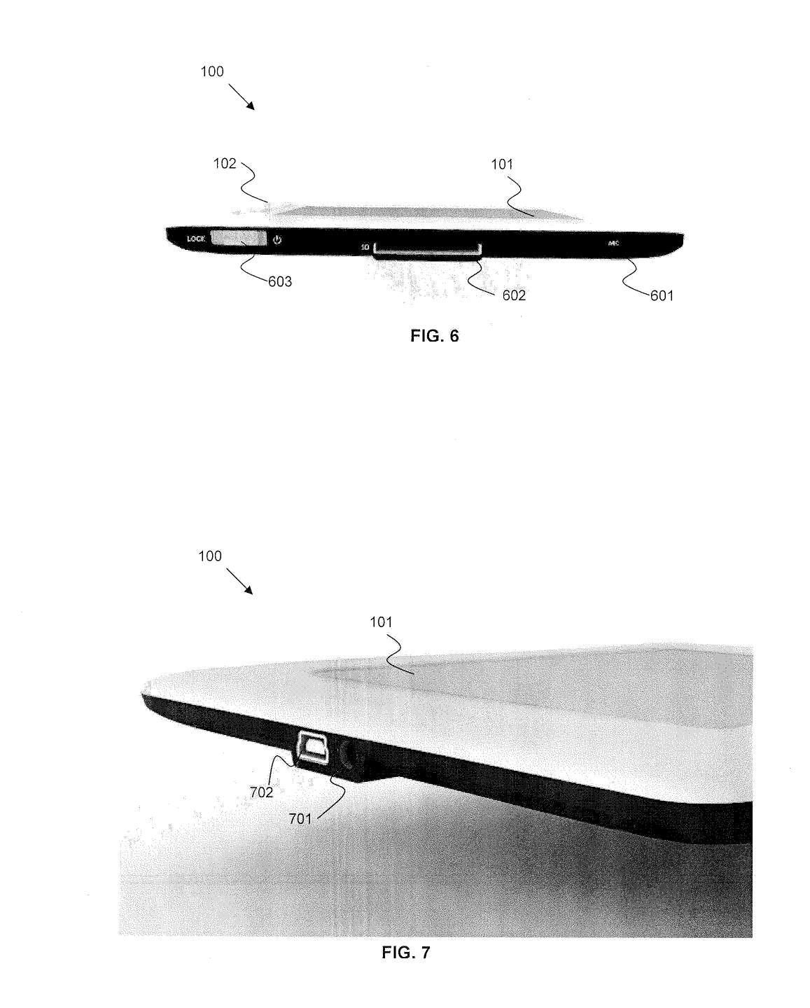

In an embodiment of the present disclosure, the electronic reading device 100 can comprise, inter glia, a central processing unit (CPU) 501, memory 502, a display controller 503, input devices 504 (e.g., touch-screen interface, physical keys, microphone), a motion detection mechanism 505, audio output devices 506 (e.g., speaker, headphone jack), a wireless transceiver 507 (e.g., Wi-Fi transceiver, Bluetooth transceiver, cellular transceiver), a network interface controller (NIC) 508, an analog-to-digital converter (ADC) 509, a digital-to-analog-converter (DAC) 510 and an input/output (I/O) interface 511, as illustrated in FIG. 5. The memory 502 can include internal random access memory (RAM), internal read only memory (ROM), external memory, such as, for example, memory inserted into a memory card slot on the device (e.g., Secure Digital (SD) card, mini SD card, micro SD card, etc.), or a combination thereof. An embodiment of the electronic reading device 100 comprising a microphone input 601 and an SD card slot 602 located next to a power/lock switch 603 is illustrated in FIG. 6. Digital content, including, but not limited to, e-book files (e.g., ePUB, mobi, pdb), audio files (e.g., mp3, AAC), picture files (e.g. JPEG, GIF, PNG), and other files (e.g., PDF, TXT, RTF) may be stored in the memory 502 and accessed by the electronic reading device 100. Text-to-speech (TTS) conversion can be utilized to read an e-book or other digital content aloud to the user via audio output devices 506, including a speaker or headphones connected to the headphone jack 701, which is shown in FIG. 7. FIG. 7 also illustrates a connection port 702 (e.g., mini-USB port, micro-USB port, etc.) that can be used to connect the electronic reading device 100 to a computer or an electrical outlet to transfer digital content to the device 100 and to charge the device 100.

In an embodiment of the present disclosure, audio notes may be recorded via the microphone 601 and associated with a particular body of text of an e-book for instant recall at a later time. For example, a user may record and save an audio note in reference to a body of text on page 25 of an e-book. When the user later selects the audio note for playback, the electronic reading device 100 will simultaneously play the audio note and display page 25 of the e-book. An analog-to-digital converter (ADC) 509 and digital-to-analog converter (DAC) 510 can be utilized to record and play back audio notes in this embodiment.

According to embodiments of the present disclosure, digital content for the electronic reading device 100 may be obtained in a variety of ways. For example, digital content may be transferred from a computer to a memory card and the memory card may be inserted into the memory card slot 602 on the device 100. Similarly, a computer may be connected to the device 100 via the connection port 702 and digital content may be transferred from a computer to the memory 502 of the device 100 via the wired connection. The electronic reading device 100 may access the content directly from the external memory card or the content may be transferred from the external memory card to the device's internal memory for storage and access. The electronic reading device 100 may further include a network internet controller (NIC) 508 (e.g., Ethernet) or a wireless transceiver 507 to obtain digital content wirelessly. For example, according to an embodiment of the present disclosure, the electronic reading device 100 may include a Wi-Fi transceiver, a Bluetooth transceiver and a cellular transceiver to receive digital content via different wireless communication technologies. The electronic reading device 100 may also utilize the NIC 508 or the wireless transceiver 507 to access the Internet.

Although exemplary embodiments of the present invention have been described hereinabove, it should be understood that the present invention is not limited to these embodiments, but may be modified by those skilled in the art without departing from the spirit and scope of the present invention, as defined by the appended claims.

What is claimed is:

1. An electronic reading device, comprising:
a display;
an actuator adjacent to a first side of the display and a plurality of keys adjacent to a second side of the display, opposite the first side of the display, symmetrically controlling the electronic reading device; and
an orientation detection mechanism detecting an orientation change of the electronic reading device,
wherein, upon detecting an orientation change of approximately 180 degrees, the actuator and the plurality of keys are redefined to perform identical functions in a current orientation as were performed in a previous orientation.

2. The electronic reading device of claim 1, wherein the actuator and the plurality of keys are configured for right-handed use in the previous orientation and are reconfigured for left-handed use in the current orientation.

3. The electronic reading device of claim 1, wherein the actuator comprises a rocker bar, and pushing the rocker bar in a first direction performs a first function and pushing the rocker bar in a second direction, opposite the first direction, performs a second function.

4. The electronic reading device of claim 3, wherein the first function comprises displaying a subsequent page of an e-book and the second function comprises displaying a previous page of the e-book.

5. The electronic reading device of claim 1, wherein the plurality of keys comprises at least one of a physical key or an onscreen key.

6. The electronic reading device of claim 1, wherein the orientation detection mechanism comprises one of an accelerometer, a gyroscope or a tilt switch array.

7. The electronic reading device of claim 3, wherein the rocker bar is parallel to a longer side of the display and a length of the rocker bar is approximately equal to a length of the longer side of the display.

8. The electronic reading device of claim 1, wherein the display comprises a touch-screen interface and one of an electronic ink (e-Ink) display, a liquid crystal display (LCD) or an organic light emitting diode (OLED) display.

9. The electronic reading device of claim 1, further comprising at least one of a Wi-Fi transceiver, a Bluetooth transceiver or a cellular transceiver.

10. The electronic reading device of claim 1, further comprising a memory card slot.

11. The electronic reading device of claim 1, further comprising a light source illuminating the display.

12. A method for operating an electronic reading device, comprising the steps of:
performing a first function in response to a switch being pushed in a first direction and performing a second function in response to the switch being pushed in a second direction; and
redefining the switch such that pushing the switch in the first direction performs the second function and pushing the switch in the second direction performs the first function, upon detecting an orientation change of the electronic reading device of approximately 180 degrees.

13. The method of claim 12, wherein the first function comprises displaying a subsequent page of an e-book and the second function comprises displaying a previous page of the e-book.

14. The method of claim 12, further comprising the step of turning off a display of the electronic reading device, upon turning the electronic reading device upside down.

15. The method of claim 12, further comprising the step of entering a low power mode, upon turning the electronic reading device upside down.

16. The method of claim 12, further comprising the steps of:
recording an audio note;
associating the audio note with a particular body of text of an e-book; and
playing the audio note and displaying the particular body of text, simultaneously, in response to a user input.

17. A method for operating an electronic reading device, comprising the steps of:
displaying a subsequent page of an e-book in response to a rocker bar being pushed in a first direction;
displaying a previous page of the e-book in response to the rocker bar being pushed in a second direction, opposite the first direction;
scrolling text on a display down in response to pushing a first key;
scrolling text on the display up in response to pushing a second key;
upon detecting an orientation change of the electronic reading device of approximately 180 degrees, inverting content on the display, displaying a subsequent page of the e-book in response to the rocker bar being pushed in the second direction, displaying a previous page of the e-book in response to the rocker bar being pushed in the first direction, scrolling text on the display down in response to pushing the second key and scrolling text on the display up in response to pushing the first key.
